(19) United States
(12) Patent Application Publication
(10) Pub. No.: US 2012/0086915 A1
(43) Pub. Date: Apr. 12, 2012

(54) Image Projection Apparatus Tiling System and Method

(75) Inventors: Andrew T. Rosen, Lynnwood, WA (US); Michael Lee Schaaf, Bainbridge Island, WA (US); David Lashmet, Bainbridge Island, WA (US)

(73) Assignee: MICROVISION, INC., Redmond, WA (US)

(21) Appl. No.: 12/898,953

(22) Filed: Oct. 6, 2010

(51) Int. Cl. G03B 21/26; G03B 21/00

(52) U.S. Cl. 353/30; 353/122

(57) ABSTRACT

In one tiling system described below, a first portable projection device (101) projects a first image (103) on a projection surface (105). A periphery delimiting light source projects a peripheral image demarcation (107), which can be non-visible light, about the first image (103). A second portable projection device (102) projects a second image (104) on the projection surface (105) with a second peripheral image demarcation (106). The first peripheral image demarcation (107) and the second peripheral image demarcation (106) can be uniquely encoded. A control circuit (229) that is operable with the one or more light sources and a light modulator is configured to tile images by altering its image as a function of the peripheral image demarcations.

### BACKGROUND

1. Technical Field

This invention relates generally to image projection devices, and more particularly to portable image projection devices.

2. Background Art

Projection systems are commonly used in business and personal applications for media presentations and entertainment. While projectors used to be large, heavy devices that were placed on a table or suspended from the ceiling, the advent of compact projection systems, such as those employing lasers, now allows a user to hold a the projection system in the palm of his or her hand. By way of example, PicoP® projection systems manufactured by Microvision, Inc. of Redmond, Wash. can be integrated into handheld devices for the projection of pictures, movies, streaming video, and presentations.

Sophisticated image projection systems, such as those found in aviation flight simulators, are capable of “tiling.” Tiling occurs when multiple fixed-position projectors are projecting images that overlap. A common processor controlling the multiple projectors can tile the images so that visible artifacts occurring in overlapping regions do not distract a viewer.

This “miniaturization” of projection systems has created a new set of issues for users, however. For example, it would be desirable to provide tiling in portable systems. Thus, there is a need for a portable image projection system capable of tiling.

### BRIEF DESCRIPTION OF THE DRAWINGS

FIG. 1 illustrates one projection tiling system configured in accordance with embodiments of the invention.

FIG. 2 illustrates a user projecting images with one portable image projection system configured in accordance with embodiments of the invention.

FIG. 3 illustrates one portable image projection system configured in accordance with embodiments of the invention.

FIG. 4 illustrates another portable image projection system configured in accordance with embodiments of the invention.

FIG. 5 illustrates one portable projection system configured in accordance with embodiments of the invention.

FIG. 6 illustrates a schematic block diagram of one portable projection system configured in accordance with embodiments of the invention.

FIG. 7 illustrates various optional motion detectors that can be used to determine portable image projection system changes in location in accordance with one or more embodiments of the invention.

FIG. 8 illustrates another projection tiling system configured in accordance with embodiments of the invention.

FIGS. 9-11 illustrate exemplary and illustrative tiling schemes and image alteration techniques suitable for a plurality of projectors in accordance with one or more embodiments of the invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION OF THE INVENTION

Before describing in detail embodiments that are in accordance with the present invention, it should be observed that the embodiments reside primarily in combinations of method steps and apparatus components related to tiling images with portable image projection systems. Accordingly, the apparatus components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

It will be appreciated that embodiments of the invention described herein may be comprised of one or more conventional processors and unique stored program instructions that control the one or more processors to implement, in conjunction with certain non-processor circuits, some, most, or all of the functions of tiling images, and optionally controlling image projection and spatial modulation of portions of a projected image based upon the tiling techniques, methods, and apparatuses described herein. The non-processor circuits may include, but are not limited to, microprocessors, scanning mirrors, image encoding devices, memory devices, clock circuits, power circuits, and so forth. As such, these functions may be interpreted as steps of a method to perform reference line management or image portion manipulation. Alternatively, some or all functions could be implemented by a state machine that has no stored program instructions, or in one or more application-specific integrated circuits, in which each function or some combinations of certain of the functions are implemented as custom logic. Of course, a combination of the two approaches could be used. It is expected that one of ordinary skill, notwithstanding possibly significant effort and many design choices motivated by, for example, available time, current technology, and economic considerations, when guided by the concepts and principles disclosed herein, will be readily capable of generating such programs and circuits with minimal experimentation.

Embodiments of the invention are now described in detail. Referring to the drawings, like numbers indicate like parts throughout the views. As used in the description herein and throughout the claims, the following terms take the meanings explicitly associated herein, unless the context clearly dictates otherwise: the meaning of “a,” “an,” and “the” includes plural reference, the meaning of “in” includes “in” and “on.” Relational terms such as first and second, top and bottom, and the like may be used solely to distinguish one entity or action from another entity or action without necessarily requiring or implying any actual such relationship or order between such entities or actions. Also, reference designators shown herein in parenthesis indicate components shown in a figure other than the one in discussion. For example, talking about a device (10) while discussing figure A would refer to an element, 10, shown in figure other than figure A.

Embodiments of the present invention provide a portable image projection system that is configured for tiling with one or more other portable image projection systems. In one embodiment, the portable image projection systems are configured with a periphery delimiting light source that projects a peripheral image demarcation about a projected image. In one embodiment, the peripheral image demarcation can be configured as a border about the image.

The periphery delimiting light source can be configured as a non-visible light source, such as an infrared light source, to ensure that dark images are not adversely affected by additional visible light. Further, the peripheral image demarcation can be uniquely encoded, such as with a unique number of peripheral image demarcation presentations per second. The periphery delimiting light source can be projected as a mask atop the projected image, or alternatively may be modulated with a spatial light modulator of the portable image projection system within or about the projected image.

The portable image projection system is then configured with a detector that received reflections of one or more peripheral image demarcations from the projection surface. Illustrating by way of example, where three similarly configured image projection systems are projecting overlapping images, three peripheral image demarcations will be present on the projection surface. The detector is configured to detect reflections from the periphery delimiting light source and thus detect each of the peripheral image demarcations. Where each of the peripheral image demarcations is uniquely encoded, a control circuit operable with the detector is configured to distinguish other peripheral image demarcations from its own. Accordingly, the control circuit can distinguish each of the peripheral image demarcations as coming from a unique source.

An optional communication circuit can then link the image projection systems. Control circuitry can determine a master and one or more slaves in a master-slave relationship. This can be accomplished by random number selection, highest or lowest serial number, and so forth. Once the master has been determined, the control circuits in slave devices can be configured to alter their images as a function of the detected peripheral image demarcations. For example, in one embodiment the slave devices can be configured to crop, translate, or scale their images so as to fit within a union of the peripheral image demarcations. In another embodiment, the slave devices can be configured to crop, translate, or scale their images so as to fit within complement areas about the various peripheral image demarcations. Other tiling schemes can be used as well.

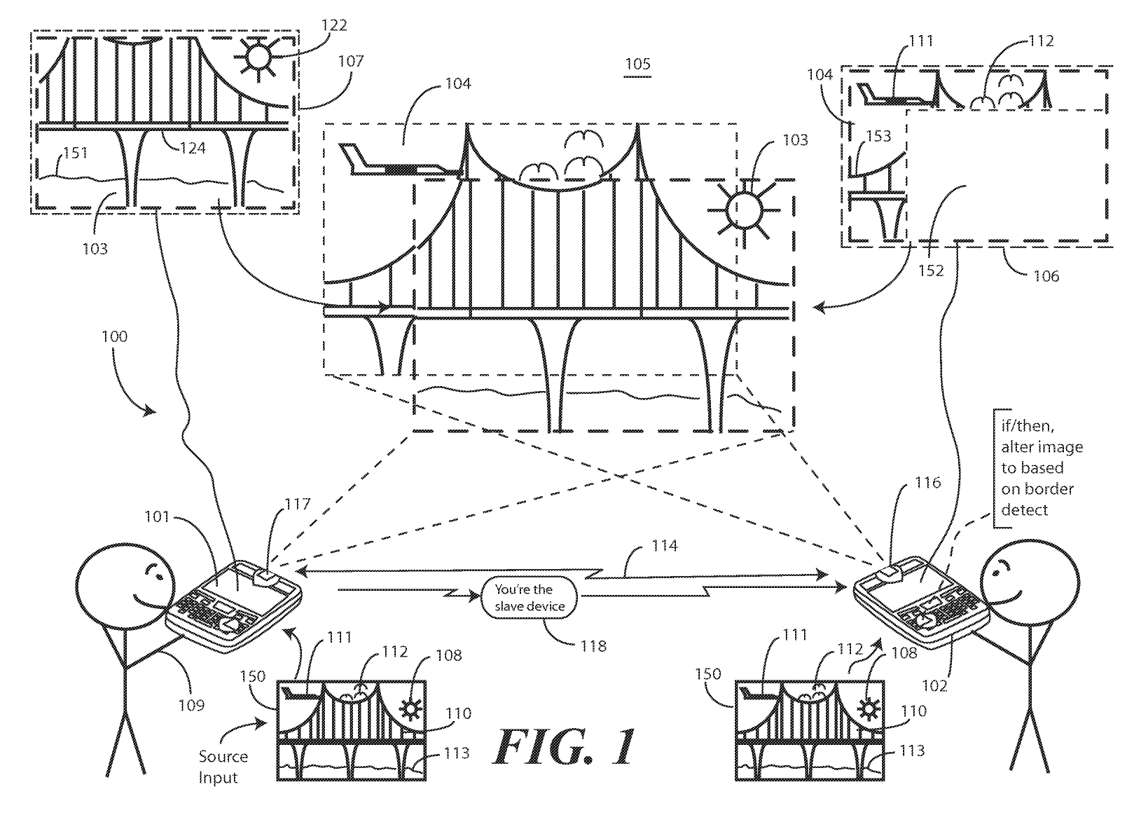

Turning now to FIG. 1, illustrated therein is one embodiment of a projection tiling system 100 configured in accordance with one or more embodiments of the invention. A first portable projection device 101 is configured to project a first image 103 on a projection surface 105. The first image 103 is a portion of a source input 150. While the first image 103 could be the entire source input image, the user 109 has elected to project only a portion of the source input 109. This decision could be based upon a desired scaling, image resolution, image clarity for an audience, and so forth. In this illustrative example, the source input 150 includes a bridge 110, an airplane 111, a water line 113, a flock of birds 112, and a sun. Based upon the user's desired image scaling, the first image 103 includes a bridge portion 124, a sun portion 122, and a water line portion 151.

The first portable projection device 101 is equipped with a periphery delimiting light source that is configured to produce a peripheral image demarcation 107 about the image. In one embodiment, the periphery delimiting light source is configured as a non-visible light source, such as an infrared or ultraviolet light source. While visible light sources can also be used, the use of a non-visible light source, such as an infrared light source, offers an advantage in that when the first portable projection device 101 is producing dark or black images, the non-visible light source will not affect that image as seen by the user 109.

A second portable projection device 102 is projecting a second image 104 on the projection surface 105. The second image 104 includes a pixel negation portion 152, in which no pixels or image data is shown. The manner of determining the pixel negation portion 152 will be explained below. For the moment, in this illustrative example, it is sufficient to note that the second image 104 includes the airplane 111, the flock of birds 112, and a second bridge portion 153. The second bridge portion 153 is the complement of the bridge portion 124 in the first image 103. In this illustrative embodiment, the source input 150 is common among projection devices. However, it will be clear to those of ordinary skill in the art having the benefit of this disclosure that the source input could be unique to each of the projection devices. In this latter scenario, the first image 103 and second image 104 would project different image data. Illustrating by example, the first image 103 may be background images such as buildings on a black background, while the second image is video of a person walking between the buildings.

As with the first portable projection device 101, the second portable projection device 102 is equipped with a periphery delimiting light source that is configured to produce a second peripheral image demarcation 106 that corresponds to the second image 104. In this illustration, the second peripheral image demarcation 106 is configured as a border created by infrared light.

The first peripheral image demarcation 107 and the second peripheral image demarcation can be created and configured in a variety of ways. As will be explained in more detail below, in one embodiment the periphery delimiting light sources can be configured to deliver demarcations directly to the projection surface 105 so as to produce a mask image atop or about a projected image. For example, the periphery delimiting light source can be configured to project a border directly on the projection surface 105 about a projected image.

In another embodiment, a common spatial light modulator can modulate both the periphery delimiting light source and the image projecting light sources. In this embodiment, the peripheral image demarcations can be configured as components within, atop, or about the image. Further, the peripheral image demarcations can be configured in more complex ways, such as words, predetermined shapes, and so forth.

In one embodiment, the first peripheral image demarcation 107 and the second peripheral image demarcation 106 are uniquely encoded. In one embodiment, the encoding occurs in accordance with a unique identification function. The encoding can be accomplished in a variety of ways. For instance, where the peripheral image demarcation is configured as a mask border about an image, the encoding can be accomplished by pulsing the peripheral image demarcation a predetermined number of periphery delimiting light source pulses per unit time. The number of pulses can be based upon a predetermined number sequence assigned to each projection device, a series of numbers, such as a series of prime numbers, and so forth. Illustrating by example, where the number of pulses was the series of prime numbers, i.e., 2, 3, 5, 7, 11, 13, etc., the first peripheral image demarcation may be pulsed two times per second while the second peripheral image demarcation is pulsed eleven times per second.

In another embodiment, such as in a portable projection system where a common spatial light modulator can modulate both the periphery delimiting light source and the image projecting light sources, the peripheral image demarcation can be coded by scanning the periphery delimiting light source. Control circuits of the portable projection systems can be configured to selectively actuate the periphery delimiting light source while the spatial light modulator sweeps the image to form peripheral image demarcations configured as words, numbers, and other unique identifiers.

In one embodiment, a first control circuit 117 operating within the first portable projection device 101 is configured to establish a communication link 114 with a control circuit 116 of the second portable projection device 102, or vice versa. One of the first control circuit 117 or the second control circuit 116 can then designate the other as a slave in a master-slave relationship. The determination of which is the master can be accomplished in a variety of ways, such as by which device has the highest serial number, which has the lowest serial number, which device controls a token in a token-ring arrangement, which device has the higher communication address, which device has the lowest communication address, and so forth. In the illustrative embodiment of FIG. 1, the first control circuit 117 has designated itself the master and sends a notification 118 to the second control circuit 116 designating the second portable projection device 102 as the slave device. This notification 118 can be transmitted to the second control circuit 116 across the communication link 114.

Upon the second control circuit 116 determining it is the slave, the second control circuit 116 can then alter the second image 104 that its projecting based upon the detected image delimiters. This results in the pixel negation portion 152 being included in the second image 104.

As shown in the center of FIG. 1, when the users direct the portable projection devices to overlap on the projection surface 105, the first image 103 and second image 104 overlap to form tiled images. Since the second portable projection device 102 is designated the slave, its control circuit 116 is configured to alter the second image 104 as a function of the intersection of the first peripheral image demarcation 107 and the second peripheral image demarcation 106. In the illustrative configuration shown in FIG. 1, the alteration scheme is defined as negating pixels within the pixel negation portion 152 so that the second image 104 fits about, or becomes the complement of, the first image 103 to form a tiled image 154 that is larger than either the first image 103 or the second image 104. Accordingly, the pixel negation portion 152 of the second image 104 being “blank.” As shown, this renders the bridge 110 to be the second bridge portion 153 and the sun 108 to not be present. Since the first portable projection device 101 is the master, the first image 103 remains in its original state.

In one embodiment, each of the first portable projection device 101 and the second portable projection device 102 can be equipped with a motion detector that is operable with the control circuit 117,116. When the control circuits 117,116 detect that the first portable projection device 101 or the second portable projection device 102 has moved, the control circuits 117,116 can be configured to re-alter the image as the function of the one or more peripheral image demarcations detected by the detector. In another embodiment, the portable projection systems can be configured with photodetectors configured to periodically determine whether the projection systems are projecting images. Where they are not, the various systems in the projection systems can be turned OFF or placed in a low-power or sleep mode.

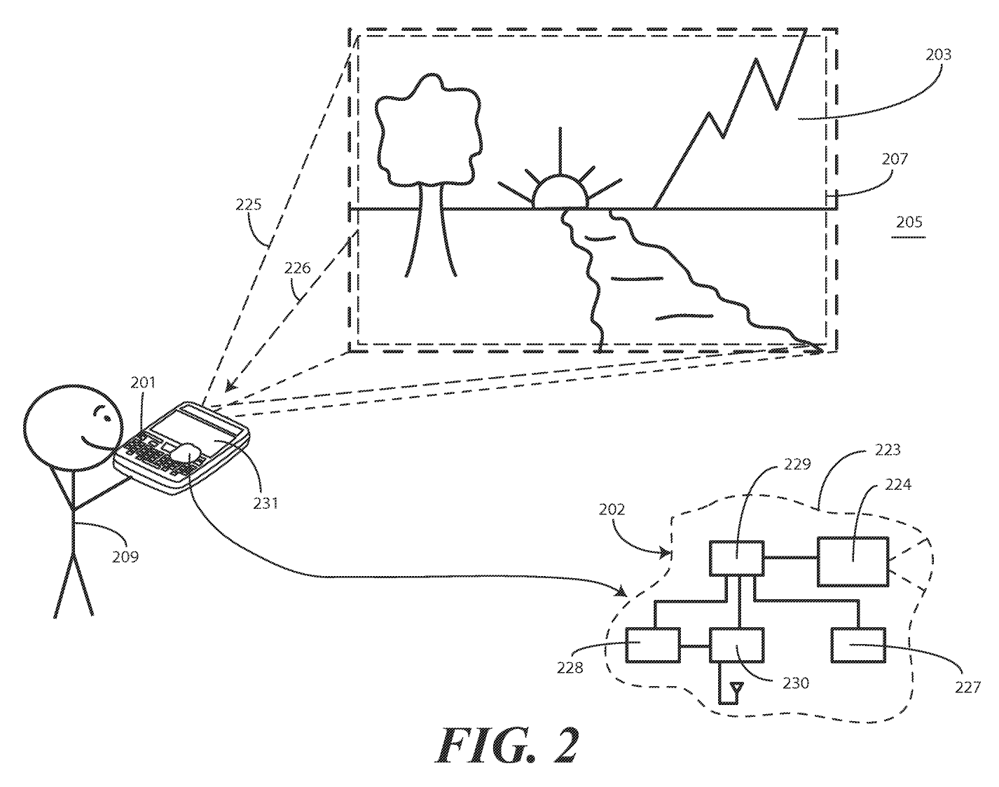

Turning now to FIG. 2, illustrated therein is a user 209 employing a portable image projection system 201 configured for tiling with one or more other projection systems in accordance with one or more embodiments of the invention. For example, the portable image projection system 201 of FIG. 2 could be used to tile images with the first portable projection device (101) and second portable projection device (102) of FIG. 1. A schematic block diagram 223 of the portable image projection system 201 is shown to the side to illustrate one or more of the internal components of the portable image projection system 201.

The portable image projection system 202 comprises an image projector 224 having one or more light sources configured to deliver one or more light beams to a spatial light modulator configured to produce an image 203 on a projection surface 205. The image 203 can be a still image or a video image. The image 203 can be recorded imagery stored in memory 228, such as photographs, computerized tomography scans, or recorded video. Alternatively, the image 203 can be generated or synthesized content, such as computer-generated graphics, or streaming video or images.

The image projector 224 may be any type of projector suitable for inclusion in a portable, hand-held electronic device. For example, in one embodiment, the image projector 224 is configured as a small, light, battery-operated projector. For illustration purposes, some embodiments of the image projector 224 described herein will be configured as laser-based systems, such as a micro-electro mechanical system (MEMS)-based projector that includes an electromagnetic driver and one or more resonating mirrors or spatial light modulators. However, it will be clear to those of ordinary skill in the art that embodiments of the invention are not so limited. Laser-based scanning mirror systems described herein may be substituted with other types of projection systems, such as a digital light projection systems or liquid crystal on silicon systems using any of light emitting diode light sources, laser light sources, color filters, and so forth.

In one embodiment, the image projector 224 also comprises a periphery delimiting light source configured to produce a peripheral image demarcation 207 about the image 203. In the illustrative embodiment of FIG. 2, the periphery delimiting light source comprises an infrared light source configured to project infrared beams 225 to create the peripheral image demarcation 207. A detector 227 receives reflections 226 of the peripheral image demarcation 207. Examples of suitable detectors 227 include a charge-coupled device or a CMOS-photodetector. Upon receiving the reflections 226, the detector 227 can then generate signals for a control circuit 229.

Since the periphery delimiting light source is an infrared light source in this illustrative embodiment, the reflections comprise non-visible light. Note that where the projection surface 205 inhibits some of the reflections 226, such as where the projection surface 205 comprises an infrared absorbing material or is a partially transparent material, the detector 227 can be configured to identify partial or incomplete peripheral image delimiters as well.

As noted above, in one embodiment the peripheral image demarcations 207 are each coded in accordance with a unique identification function. In one embodiment, the unique identification function comprises a predetermined number of periphery delimiting light source pulses per unit time. For example, the predetermined number of periphery delimiting light source pulses per unit time can comprise a prime number of pulses per second. When used in a system, such as the system (100) of FIG. 1, each portable image projection system 201 can be configured to pulse its peripheral image demarcation 207 for a predetermined, unique prime number of pulses per second. A first portable image projection system can pulse a first prime number of pulses, a second can pulse a second prime number of pulses, and so forth.

A control circuit 229 that is operable with the one or more light sources and the light modulator of the image projector 224 is configured to alter the image 203 as a function of the one or more peripheral image demarcations 207 detected by the detector 227. The control circuit 229 can be any of a microprocessor, programmable logic, an application specific integrated circuit, or other device.

The alteration of the image can take any of a number of forms. In one embodiment, the control circuit is 229 is configured to alter the image 203 by cropping the image 203. In another embodiment, the control circuit 229 is configured to alter the image 203 by scaling the image 203. In yet another embodiment, the control circuit 229 is configured to alter the image 203 by translating the image 203. Of course, combinations of these may be employed. Further, this list is illustrative only and is not intended to be limiting in that those of ordinary skill in the art having the benefit of this disclosure that numerous other image alteration techniques can be used with the embodiments disclosed herein.

The image alteration performed by the control circuit 229 can result in different effects when the image 203 is tiled with another image. As described above, in one embodiment a plurality of portable image projection systems can determine via communication circuits 230 a master and slaves in a master-slave relationship. For discussion purposes, the master will be considered to be a portable image projection system that will be configured to present its entire image. Where the portable image projection system 201 is configured as a slave, the control circuit 229 can alter the image 203 such that the image fits within the master's image, about the master's image, and so forth.

In one embodiment, the control circuit 229 is configured to alter the image 203 by configuring the image 203 to project about detected peripheral image demarcations other than those projected by the periphery delimiting light source of the portable image projection system 200. The control circuit 229 can be configured to determine which detected peripheral image demarcation is associated with which portable image projection device when the detected peripheral image demarcations are each encoded with unique identification functions. Accordingly, the control circuit 229 can be configured to alter the image 203 by configuring the image 203 to project within a union of the one or more peripheral image demarcations detected by the detector 227. Alternatively, the control circuit 229 can be configured to alter the image 203 by configuring the image 203 to project within a complement of the one or more peripheral image demarcations detected by the detector 227. Other alteration schemes will be readily apparent to those of ordinary skill in the art having the benefit of this disclosure.

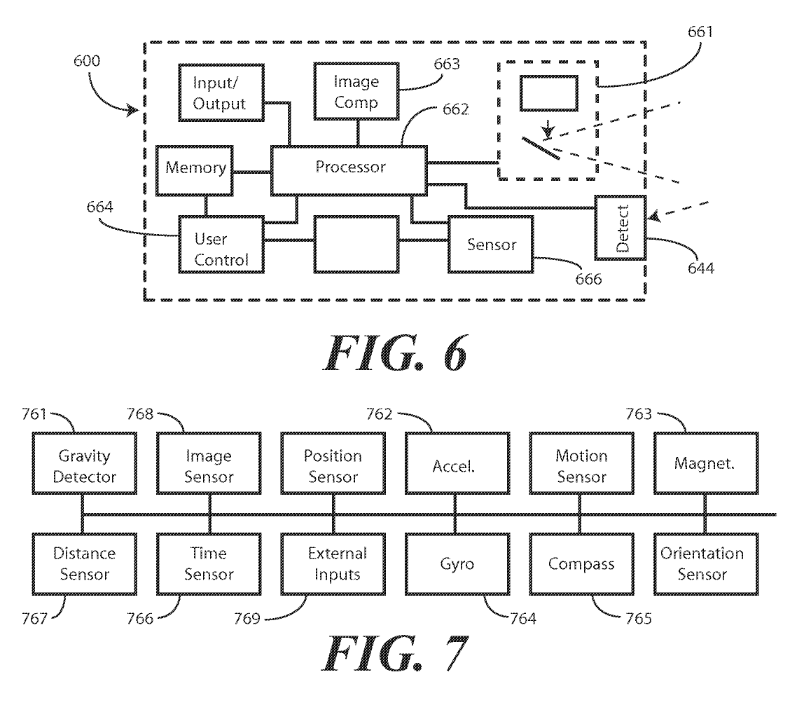

With the portable image projection device 201 of FIG. 2, spontaneous tiling of systems can be accomplished when the peripheral image demarcations of other projection systems are detected. Synchronization of the tiled images can begin when the first peripheral image demarcation is detected. In one embodiment, the synchronization process can end when the images are tiled and the various portable image projection systems are at rest. As will be described with reference to FIGS. 6 and 7, the portable image projection systems can be equipped with motion detectors that initiate a resynchronization process when the portable image projection systems move.

In one embodiment, the control circuit 229 is configured to present an optional tiling user interface on a display 231 of the device. In one embodiment, the tiling user interface can be actuated from a menu. The user 209 can selectively turn ON and OFF the tiling feature. Accordingly, when the user 209 is interested in tiling images with another user, the user 209 can actuate the tiling feature with the user interface. Where the optional tiling user interface is included, it permits the periphery delimiting light source and detector 227 to remain OFF until needed, thereby conserving power.

In another embodiment, the control circuit 229 of the portable image projection system 201 is configured to detect the proximate presence of another system through the communication circuit 230. For example, using a near-field communication technology, the portable image projection system 201 can wirelessly communicate with the other system to determine its presence. This wireless communication can then be used to actuate the periphery delimiting light source and the detector 227. As noted above, the wireless communication can then be used to determine which device is the master and which other devices are the slaves.

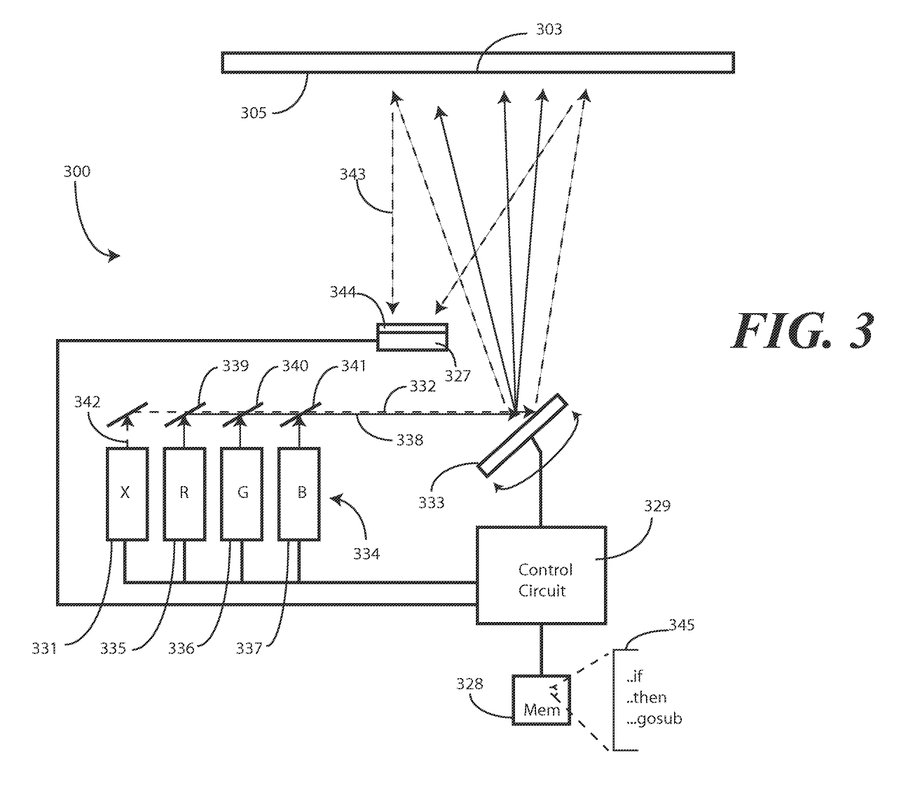

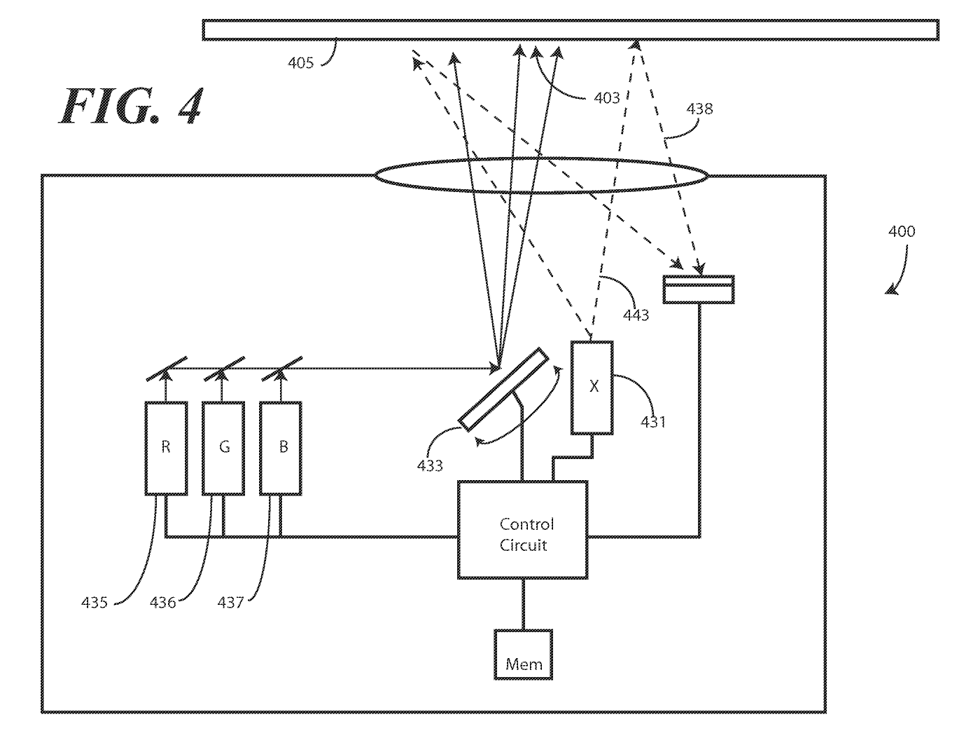

As noted above, the peripheral image demarcation can be masked upon the image in one embodiment. In another embodiment, light from the periphery delimiting light source can be modulated with the spatial light modulator of the image projection system. Turning now to FIGS. 3 and 4, an example of each version will be shown in more detail.

Beginning with FIG. 3, illustrated therein is a portable projection system 300 configured in accordance with one embodiment of the invention. The portable projection system 300 is capable of tiling an image 303 with at least one other projection system and includes an additional light source 331, i.e., the periphery delimiting light source, which is configured to produce an image delimiting light beam 332. The image delimiting light beam 332 is then delivered to a spatial light modulator 333.

The illustrative portable projection system 300 of FIG. 3 is a laser-based system, although it will be clear to those of ordinary skill in the art having the benefit of this disclosure that the tiling systems and methods described herein could be used with non-laser based systems as well. In the system of FIG. 3, one or more laser sources 334 are configured to produce a plurality of light beams. In one embodiment, the one or more laser sources 334 comprise a red laser 335, a blue laser 336, and a green laser 337, as indicated by the “R,” “G,” and “B” in the illustrative embodiment of FIG. 3. Note that where lasers are used as light sources, the lasers can be any of various types of lasers. For example, in one embodiment, each laser source comprises a semiconductor laser, as these lasers are small and efficient. Edge-emitting lasers can be used as the laser sources, as can vertical cavity surface emitting lasers. Such semiconductor lasers are well known in the art and are commonly available from a variety of manufacturers.

The spatial light modulator 333 is then configured to produce images by spatially or angularly encoding the light 338 from the laser sources 334 along a projection surface 305. In one embodiment, the spatial light modulator 333 comprises a Micro-Electro-Mechanical-System (MEMS) scanning mirror, such as those manufactured by Microvision, Inc. Examples of MEMS scanning mirrors, such as those suitable for use with embodiments of the present invention, are set forth in commonly assigned U.S. patent application Ser. No. 11/786,423, filed Apr. 10, 2007, entitled, “Integrated Photonics Module and Devices Using Integrated Photonics Module,” which is incorporated herein by reference, and in U.S. Published patent application Ser. No. 10/984,327, filed Nov. 9, 2004, entitled “MEMS Device Having Simplified Drive,” which is incorporated herein by reference. While a scanning mirror is one type of spatial light modulator suitable for use with embodiments of the invention, it will be clear to those of ordinary skill in the art having the benefit of this disclosure that the invention is not so limited. Other types of spatial light modulators, such as a spinning wheel found digital light projection technology systems, can also be used.

To facilitate freedom of design, one or more optional optical alignment devices 339,340,341 may be used to direct light beams from the one or more laser sources 334 to the spatial light modulator 333. For example, the one or more optical alignment devices 339,340,341, in one embodiment, are used to orient the plurality of light beams into a single, collimated light beam. In one embodiment, dichroic mirrors are used as the one or more optical alignment devices 339,340,341. Dichroic mirrors are partially reflective mirrors that include dichroic filters that selectively pass light in a narrow wavelength bandwidth while reflecting others. In one embodiment, polarizing coatings can be incorporated into the dichroic mirrors as well. Dichroic mirrors and their use in laser-based projection systems are known in the art and, as such, will not be discussed in further detail here. Note that the location, as well as the number, of the optical alignment devices 339,340,341 can vary based upon application. For example, in some MEMS-type scanning systems, the plurality of light beams can be delivered directly to the scanning mirror.

In the embodiment of FIG. 3, a non-visible light source 331 serves as the periphery-delimiting beam and is co-located with the visible red laser 335, blue laser 336, and green laser 337. Such a configuration is useful in that people may view a visible image without being distracted by a periphery-delimiting beam. However, it will be clear to those of ordinary skill in the art having the benefit of this disclosure that the invention is not so limited. For example, other applications, such as machine-based applications in factories, may use non-visible light to perform periphery delimitation. A barcode reader, for instance, may create bar code reading images with infrared or ultraviolet light, while periphery delimitation may be performed with a visible light so as to be detectable by a person.

As noted above, the non-visible light source 331 can be, for example, an infrared light source or an ultraviolet light source. The non-visible light source 331 can be a semiconductor light source such as a light emitting diode. One example of a non-visible light source 331 is that of an infrared light emitting diode having a wavelength of around 800-810 nanometers. Another example of a non-visible light source 331 is that of an ultraviolet light emitting diode having a wavelength of around 400-410 nanometers. It will be clear to those of ordinary skill in the art having the benefit of this disclosure that the invention is not so limited, as any number of non-visible light sources can be used, depending, for example, upon the size of the portable projection system 300, the intended application, and so forth.

In the illustrative embodiment of FIG. 3, the non-visible light source 331 is disposed within the portable projection system 300 such that the image delimiting light beam 332 is generally collinear with the visible light beams. An additional optical alignment device 342 can be used to orient the image delimiting light beam 332 so as to be collinear with the visible light beams. Accordingly, the spatial light modulator 333 is then able to encode the non-visible light source 331 along with the visible light beams 338 along the projection surface 305.

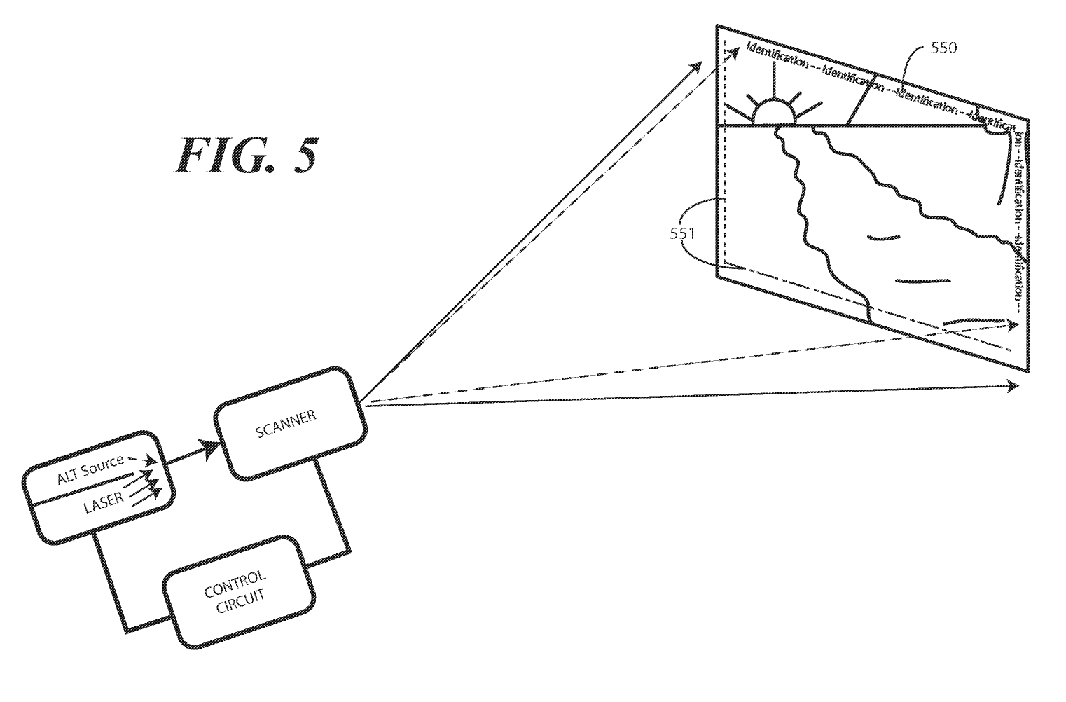

This configuration gives the designer a great deal of flexibility in designing the peripheral image delimiter. For example, rather than simply comprising a border, the peripheral image delimiter in this configuration can be configured as text, shapes, or other objects within the image. These latter objects can be referred to as “peripheral image demarcations,” although a border or border pattern can also be a peripheral image demarcation as sell. Since the spatial light modulator 333 can scan the image delimiting light beam 332 across the projection surface 305, the peripheral image delimiter can even be configured as words, such as “the border of this image is X by Y.” One example of this is shown in FIG. 5, where the peripheral image demarcation 550 is configured as words within the image.

Turning briefly to FIG. 5, illustrated therein are two examples of peripheral image demarcations. Peripheral image demarcation 550 is configured as text, while peripheral image demarcation 551 is configured as dots running vertically and a combination of dots and dashes running horizontally. Peripheral image demarcation 550 and peripheral image demarcation 551 could be used in combination, or separately. Additionally, other peripheral image demarcations could be used as well. One point worthy of note is that these peripheral image demarcations 550,551 can be used for other features as well. For example, peripheral image demarcation 551 can also be used for determining image orientation. As the detector can be configured to distinguish between the dots and the dot-dash combination, these demarcations can be used to ensure that the image is oriented horizontally on the projection surface.

Accordingly, the “peripheral image demarcations,” as defined herein, should include not only a border, but also boundary indicative shapes, objects, text, and other markings that can be included within an image. For example, the peripheral image demarcations can be lines, circles, dots, triangles, and so forth, and further may be displayed simultaneously within or about the visible images. Note that the peripheral image demarcations can further be multiplexed with the visible images. For example, where the visible images are created with light encoded in a raster pattern, the peripheral image demarcations can be projected only during certain portions of the raster pattern, such as the fly-back portion, the fly-forward portion, the vertical over-scan portion, or the horizontal over-scan portion.

Turning back to FIG. 3, the image delimiting light beam 332, upon being modulated along the projection surface 305, reflects from the projection surface 305 back to the detector 327 that is configured to receive reflections 343 of one or more peripheral image demarcations from the projection surface 305. These reflections 343 create electrical signals corresponding to the reflected beam's intensity and location on the detector 327. In one embodiment, the detector 327 is configured as a charge coupled device photodetector. In another embodiment, the detector 327 is configured as a CMOS photodetector. In yet another embodiment, the detector 327 is configured as a black silicon camera. In yet another embodiment, the detector 327 is configured as an InGaAs single photon detector. Other types of non-visible light detectors may also be used. An optional focusing optical element, such as a fixed lens, manually focused lens, or automatically focused lens, can be included to optimize signal-to-noise ratios of images captured by the detector 327.

The detector 327 effectively captures an “image” of the reflections 343 and delivers a corresponding signal to the control circuit 329. In one embodiment, the reflections 343 are each uniquely coded image delimiters, where the unique coding corresponds to an identity of the source of the image delimiter as described above. Reflections 343 can also be used for border correction, in that a portable projection system 300 can determine its border from the reflections 343 captured by the detector 327, and accordingly can determine whether its border is straight, level, or otherwise aligned.

In one embodiment, to keep the signal to noise ratio high, the detector 327 is configured with a filter 344 configured to block or absorb visible light and to allow the reflections 343 to pass to the detector 327. For example, in one embodiment where the non-visible light source 331 comprises an infrared light source, the detector 327 can comprise an infrared input filter that absorbs light in the visible spectrum but allows infrared light to pass through. In another embodiment, where the non-visible light source 331 comprises an ultraviolet light source, the detector 327 can comprise an ultraviolet filter that blocks the visible spectrum while allowing ultraviolet light to pass.

When the detector 327 captures images of the peripheral image demarcations from the projection surface 305, the detector 327 delivers the corresponding signals to the control circuit 329. The control circuit 329, which may be a microcontroller, a microprocessor, ASIC, logic chip, or other device, serves as the brain of the portable projection system 300. The control circuit 329 can include other processing units dedicated to performance of specific functions. For example, an integrated or stand-alone digital signal processor may handle the processing of incoming communication signals or data. In the illustrative embodiment of FIG. 3, the control circuit 329 is shown for simplicity as an integrated circuit, but shall be understood to be representative of any processing architecture known to those skilled in the art. The control circuit 329 can be a single processor, such as a microprocessor integrated circuit, or alternatively may comprise one or more processing units or components.

The control circuit 329 is coupled to a memory 328 or other computer readable medium. By executing operable code 345 stored in the memory 328, the control circuit 329 is capable of causing the various components of the portable projection system 300 to execute their respective functions. For example, but executing the operable code 345, the control circuit 329 can be configured to control one or more of the spatial light modulator 333 or the visible laser sources 334 to alter the image 303 as a function of the one or more peripheral image demarcations detected by the detector 327. Where the spatial light modulator 333 is a scanning mirror, the control circuit 329 can be configured to alter scanning sweeps of the spatial light modulator 333 to compress, translate, or otherwise alter the image 303. Where the control circuit 329 controls the visible laser sources 334, the control circuit 329 can be configured to alter the image 303 by selectively actuating the visible laser sources 334. Of course, a combination of the two can be performed as well. Accordingly, the control circuit 329 can be configured to scale, translate, crop, blank, or otherwise alter the image 303 as a function of an intersection of uniquely coded image delimiters.

In one embodiment, the control circuit 329 executes operable code 345 comprising one or more routines stored in the memory 328. Note that the memory 328 may comprise one or multiple memories. For example, the memory 328 may comprise a separate and distinct integrated circuit connected and operable with the control circuit 329 via a data bus. Further, the memory 328 may include one or more read-only memories, dynamic or static random-access memory, or any other type of programmable memory, such as one or more EPROMs, EEPROMs, registers, and the like. In some embodiments, the memory 328 can comprise non-traditional storage devices as well. The routines stored in the memory 328 can be stored in the form of executable software, firmware, or in any other fashion known to those skilled in the art.

In addition to the executable code 345 operable with the control circuit 329, the memory 328 may further store other information and data. For instance, in one embodiment, the control circuit 329 can be optionally configured to count or integrate successive images of image delimiters captured by the detector 327. In such an embodiment, the image data can be stored in the memory 328.

Turning now to FIG. 4, illustrated therein is an alternate portable image projection system 400 configured for tiling with one or more other projection systems in accordance with one or more embodiments of the invention. In FIG. 4, rather than being scanned by a spatial light modulator, the non-visible light source 431 is masked along the image 403 on the projection surface 305. As with FIG. 3, the visible light sources 435,436,437 are scanned along the projection surface 405 by a spatial light modulator 433. However, instead of scanning the non-visible beam 443, the non-visible light source 431 delivers the non-visible beam 443 directly to the projection surface 405.

In one embodiment, the non-visible beam 438 is delivered as a perimeter-delineating border about the image 403. This can be accomplished in a variety of ways. In one embodiment, the non-visible light source 431 comprises an infrared light emitting diode having an aperture that includes an infrared absorber. The infrared absorber blocks light in the center of the non-visible beam 443 and facilitates the projection of a robust border about the image 403 on the projection surface 405.

In another embodiment, the non-visible light source 431 comprises an edge emitting light emitting diode that is configured to project a border about the image 403 on the projection surface 405. As with the previous embodiment, the non-visible beam 443 is projected directly onto the projection surface 405, and is not modulated by the spatial light modulator 433.

Turning now to FIG. 6, illustrated therein is a schematic block diagram of one embodiment of a portable image projection system 600 configured in accordance with embodiments of the present invention. While the image (203) shown in FIG. 2 illustrated some of the components, additional components are shown in FIG. 6.

As with the image (203) of FIG. 2, the portable image projection system 600 of FIG. 6 includes an image projector 661, a processor 662 or control unit, and a detector 644. The image projector 661 can be configured to deliver a peripheral image demarcation by modulating non-visible light with a spatial light modulator as described with reference to FIG. 3, or alternatively may deliver a peripheral image demarcation directly as described with reference to FIG. 4.

As shown in FIG. 6, the portable image projection system 600 also includes an image compensation module 663. The image compensation module 663 is configured to retile and hold steady a projected image if the user's hand is moving. Embodiments of the present invention are suitable for use in hand-held devices. When such devices are projecting images, there can be some threshold level of wobble in the projected image. This wobble can be detected by movement of the peripheral image demarcation as sensed by the detector 644. Once a predetermined threshold level of wobble is detected, the image compensation device can be configured to cause the tiling to resynchronize.

A manual control module 664 can also be included. The manual control module 664 can be used to permit a user to manually control its projected image, and in one embodiment, can be used to override the automatic tiling feature. For example, where the display of the portable image projection system 600 is configured with a display, the display can present a copy of the projected image to a user. The user can then employ the input 665 of the portable image projection system 60 to extend the area of fill or deletion in the image. Predetermined scaling amounts, such as ten percent, twenty-five percent, sixty-six percent, and so forth can be provided so that the user can quickly scale to a predetermined amount.

In one embodiment described previously, the portable image projection system 600 can include a motion detector 666. The motion detector 666 can include a variety of components. Turning briefly to FIG. 7, illustrated therein are the various components that may comprise the motion detector 666. The components shown are not intended to be limiting, as it will be clear to those of ordinary skill in the art having the benefit of this disclosure that other components imparting spatial awareness can also be included.

The components used to detect system motion shown in FIG. 7 include a gravity detector 761, an accelerometer 762, a magnetometer 763, a gyroscope 764, a compass 765, a time sensor 766, a distance sensor 767, an image sensor 768, and external input sensors 769. Each of these components is known in the art, and will not be described in detail. Other devices not shown, such as a global positioning system (GPS) device, lasers, radars, electromagnetic sensors, altimeters/barometers, rangefinders, directional microphones, internal visual or non-visual (e.g., sonic) movement detectors, external visual or non-visual (e.g., sonic) movement detectors, and so forth can be used as well.

Turning now back to FIG. 6, the motion detector 666 can include any type of device capable of providing motion-based information. Motion may be measured as a change in position or orientation over time. For example, the motion detector 666 may include the gyroscope (764), working in conjunction with the magnetometer (763). The motion detector 666 can be configured to provide orientation information as well. Local orientation may be considered relative or absolute. Orientation information in one embodiment may be gathered using a second set of positional sensors, e.g., either a second gyroscope or an array of accelerometers. Some or all of the components shown in FIG. 7 can be used as the motion detector 666. Multiples of each component can be used to increase accuracy.

The portable image projection system uses detected motion for resynchronization of the tiled images. Consider the situation where images have been tiled and the various projection systems are at rest. In such a configuration, the tiling detection components could be placed into a low-power or sleep mode. Once the motion detector 666 determines that the portable image projection system 600 has moved, the tiling can resynchronize. Said differently, the processor 662 can be configured to re-alter the images upon the motion detector determining that the portable image projection system has moved. Where no motion detector 666 is present, the tiling components can be configured to recheck tiling synchronization after a predetermined amount of time as well.

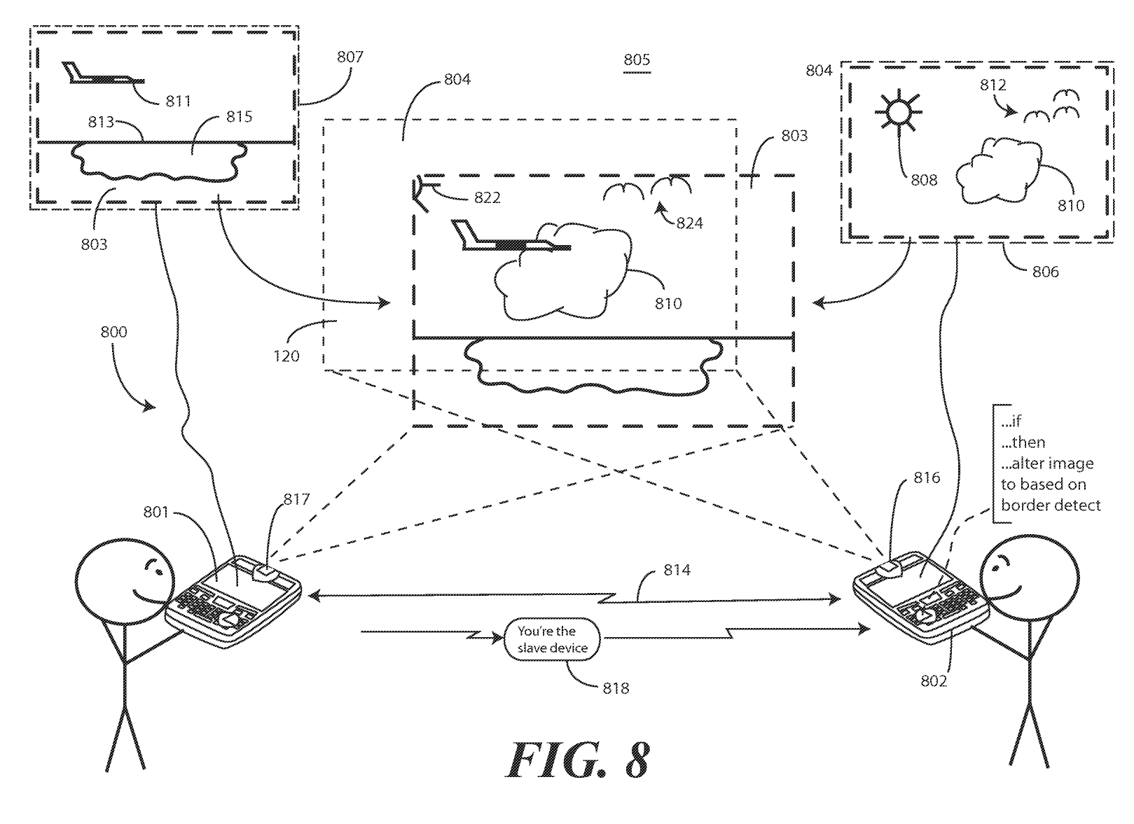

Turning now to FIG. 8, illustrated therein is an alternate embodiment of a projection tiling system 800 configured in accordance with one or more embodiments of the invention. Recall from FIG. 1 that the tiling scheme was configured to be complementary, such that the first image (103) and second image (104) tiled to become a tiled image (154) that was larger than either the first image (103) or the second image (104) alone. In FIG. 8, the tiling scheme is opposite, in that images are tiled within the union of the overlap, not the complement.

In FIG. 8, as in FIG. 1, a first portable projection device 801 is configured to project a first image 803 on a projection surface 805. In this illustrative example, the first image 803 includes an airplane 811, a horizon 813, and a lake. The first portable projection device 801 is equipped with a periphery delimiting light source that is configured to produce a peripheral image demarcation 807 about the image.

A second portable projection device 802 is projecting a second image 804 on the projection surface 805. In this illustrative example, the second image 804 includes a sun 808, a cloud 810, and a flock of birds 812. As with the first portable projection device 801, the second portable projection device 802 is equipped with a periphery delimiting light source that is configured to produce a second peripheral image demarcation 806 that corresponds to the second image 804.

A first control circuit 817 operating within the first portable projection device 801 is configured to establish a communication link 814 with a control circuit 816 of the second portable projection device 802, or vice versa. One of the first control circuit 817 or the second control circuit 816 can then designate the other as a slave in a master-slave relationship. In the illustrative embodiment of FIG. 8, the first control circuit 817 has designated itself the master and sends a notification 818 to the second control circuit 818 designating it as the slave across the communication link 814.

Upon the second control circuit 818 determining it is the slave, the second control circuit 818 can then alter the second image 804 that its projecting based upon the detected image delimiters. As shown in the center of FIG. 8, when the users direct the portable projection devices to overlap on the projection surface 805, the first image 803 and second image 804 overlap to form tiled images. Since the second portable projection device 802 is designated the slave, its control circuit 816 is configured to alter the second image 804 as a function of the intersection of the first peripheral image demarcation 807 and the second peripheral image demarcation 806. In the illustrative configuration shown in FIG. 8, the alteration scheme is defined as fitting the second image 804 within the first image 803. Accordingly, a portion 820 of the second image 804 has been blanked. As shown, this renders the sun 808 to be a partial sun 822 and the flock of birds 812 as a partial flock 824. The cloud 810 remains intact. Since the first portable projection device 801 is the master, the first image 803 remains in its original state.

Turning now to FIGS. 9-11, a few illustrative examples of tiling three or more projection devices are shown. These examples are illustrative only, and are not intended to be limiting. Those of ordinary skill in the art having the benefit of this disclosure will find other tiling schemes readily apparent.

Beginning with FIG. 9, three images 901,902,903 are shown. Each image 901,902,903 has a corresponding peripheral image demarcation 904,905,906 associated therewith. In one embodiment, the peripheral image demarcations 904,905,906 are created with non-visible light and are detectable by a corresponding detector as described above.

In the illustrative embodiment of FIG. 9, image 901 has been designated as the master image. Accordingly, it is shown to its full extent. As noted above, a communication circuit operable with the control circuit of a projection system can be configured to alter the image upon receiving a signal from another device designating the portable image projection system as a slave in a master-slave relationship. Image 902 and 903 are slave images.

In the tiling scheme of FIG. 9, the slave images are configured to display content only within the master image 901. Thus, a first portion 907 of image 902 has been deleted, while a second portion 908 of image 902 is visible. The deletion can be achieved by cropping. However, note that instead of cropping, the entirety of image 902 could be scaled and translated so as to fit within master image 901. In the latter configuration, portion 908 would represent a scaled and translated version of original image 902. Distortion correction could be applied in this case. Similarly, image 903 can be either cropped to a first portion 910 of image 903 by removing a second portion 909, or can be scaled and translated.

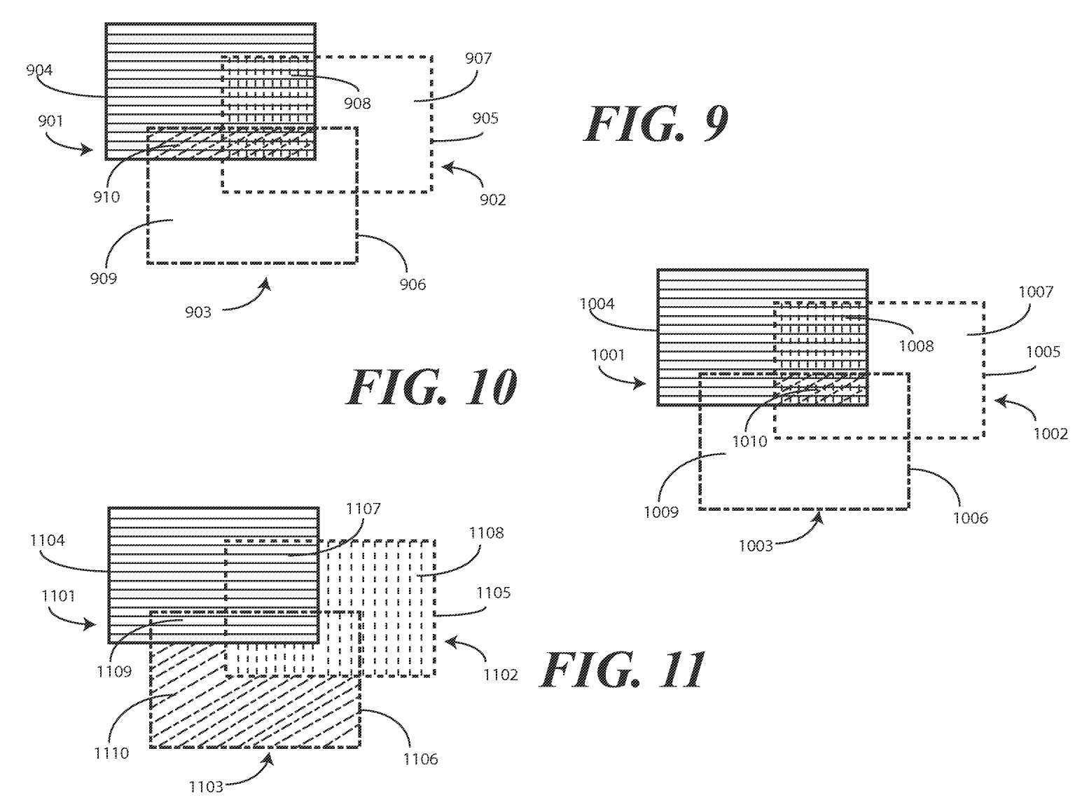

Turning now to FIG. 10, again three images 1001,1002,1003 are shown. As with FIG. 9, each image 1001,1002,1003 has a corresponding peripheral image demarcation 1004,1005,1006 associated therewith. Image 1001 is the master image, while images 1002, 1003 are slave images.

In FIG. 10, the tiling scheme is selected such that tiling is to occur at the union 1011 of the peripheral image demarcations 1004,1005,1006. Accordingly, a first portion 1007 of image 1002 has been deleted, while a second portion 1008 of image 1002 appearing within the union 1011 of the peripheral image demarcations 1004,1005,1006 is visible. As with FIG. 9, the deletion can be achieved by cropping or by scaling and translation. Similarly, image 1003 can be either cropped to a first portion 1010 of image 1003 by removing a second portion 1009, or can be scaled and translated to fit within the union 1011 of the peripheral image demarcations 1004,1005,1006.

Turning to FIG. 11, again three images 1101,1102,1103 are shown. As with FIGS. 9 and 10, each image 1101,1102,1103 has a corresponding peripheral image demarcation 1104,1105,1106 associated therewith. Image 1101 is the master image, while images 1102, 1103 are slave images.

FIG. 11 illustrates a tiling scheme opposite of that shown in FIG. 10. Rather than tiling within the union (1011), in FIG. 11, the tiling scheme is selected such that tiling is to occur at the complements of the peripheral image demarcations 1104,1105,1106. Accordingly, a first portion 1107 of image 1102 has been deleted, while a second portion 1108 of image 1102 appearing about the master image 1101 and about the peripheral image demarcations 1104,1105,1106 is visible. As with FIGS. 10 and 11, the deletion can be achieved by cropping or by scaling and translation. Similarly, image 1103 can be either cropped to a first portion 1110 of image 1103 by removing a second portion 1109, or can be scaled and translated to fit about the peripheral image demarcations 1104,1105,1106.

In the foregoing specification, specific embodiments of the present invention have been described. However, one of ordinary skill in the art appreciates that various modifications and changes can be made without departing from the scope of the present invention as set forth in the claims below. Thus, while preferred embodiments of the invention have been illustrated and described, it is clear that the invention is not so limited. Numerous modifications, changes, variations, substitutions, and equivalents will occur to those skilled in the art without departing from the spirit and scope of the present invention as defined by the following claims. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims.

What is claimed is:

1. A portable image projection system configured for tiling with one or more other projection systems, the portable image projection system comprising:
one or more light sources configured to deliver one or more light beams to a light modulator configured to produce an image on a projection surface;
a detector configured to receive reflections of one or more peripheral image demarcations from the projection surface; and
a control circuit operable with the one or more light sources and the light modulator to alter the image as a function of the one or more peripheral image demarcations detected by the detector.

2. The portable image projection system of claim 1, wherein the reflections of one or more peripheral image demarcations comprise non-visible light.

3. The portable image projection system of claim 1, wherein the one or more peripheral image demarcations are each coded in accordance with a unique identification function.

4. The portable image projection system of claim 3, wherein the unique identification function comprises a predetermined number of periphery delimiting light source pulses per unit time.

5. The portable image projection system of claim 4, wherein the predetermined number of periphery delimiting light source pulses per unit time comprises a prime number of pulses per second.

6. The portable image projection system of claim 1, further comprising a periphery delimiting light source configured to produce a peripheral image demarcation about the image.

7. The portable image projection system of claim 6, wherein the periphery delimiting light source comprises an infrared light source.

8. The portable image projection system of claim 6, wherein the control circuit is configured to alter the image by configuring the image to project about detected peripheral image demarcations other than those projected by the periphery delimiting light source of the portable image projection system.

9. The portable image projection system of claim 8, wherein the detected peripheral image demarcations other than those projected by the periphery delimiting light source are each encoded with unique identification functions.

10. The portable image projection system of claim 1, wherein the control circuit is configured to alter the image by cropping the image.

11. The portable image projection system of claim 1, wherein the control circuit is configured to alter the image by scaling the image.

12. The portable image projection system of claim 1, wherein the control circuit is configured to alter the image by translating the image.

13. The portable image projection system of claim 1, wherein the control circuit is configured to alter the image by configuring the image to project within a union of the one or more peripheral image demarcations detected by the detector.

14. The portable image projection system of claim 1, further comprising a communication circuit operable with the control circuit, wherein the control circuit is configured to alter the image only upon the communication circuit receiving a signal designating the portable image projection system as a slave in a master-slave relationship with at least one other image projection system.

15. The portable image projection system of claim 1, further comprising a motion detector, wherein the control circuit is configured to re-alter the image as the function of the one or more peripheral image demarcations detected by the detector upon the motion detector determining that the portable image projection system has moved.

16. A portable projection system capable of tiling an image with at least one other projection system, the portable projection system comprising:
one or more light sources configured to produce one or more light beams;
a spatial light modulator configured to produce images on a projection surface by scanning the one or more light beams along the projection surface;
a detector configured to receive reflections of one or more peripheral image demarcations from the projection surface; and
a control circuit operable with the one or more light sources and the spatial light modulator to alter the image as a function of the one or more peripheral image demarcations detected by the detector.

17. The portable projection system of claim 16, wherein the control circuit is configured to alter the images by altering scanning sweeps of the spatial light modulator.

18. The portable projection system of claim 16, wherein the control circuit is configured to alter the images by selectively actuating the one or more light sources.

19. The portable projection system of claim 16, further comprising an additional light source configured to produce an image delimiting light beam and to deliver the image delimiting light beam to the spatial light modulator, wherein the spatial light modulator is configured to produce a uniquely coded image delimiter for the images.

20. A projection tiling system, comprising:
a first portable projection device configured to project a first image and a first uniquely coded image delimiter corresponding to the first image;
a second portable projection device configured to project a second image and a second uniquely coded image delimiter corresponding to the second image;
a first control circuit operating within one of the first portable projection device or the second portable projection device configured to designate another of the first portable projection device or the second portable projection device as a slave; and
a second control circuit operating within the another of the first portable projection device or the second portable projection device configured to alter an image projected therefrom as a function of an intersection of the first uniquely coded image delimiter and the second uniquely coded image delimiter.
